(19) United States
(12) Patent Application Publication
(10) Pub. No.: US 2023/0093151 A1
(43) Pub. Date: Mar. 23, 2023

(54) VEHICLE-EXTERIOR-NOTIFICATION CONTROL DEVICE, VEHICLE-EXTERIOR-NOTIFICATION CONTROL SYSTEM, AND VEHICLE-EXTERIOR-NOTIFICATION CONTROL METHOD

(71) Applicant: Mitsubishi Electric Corporation, Tokyo (JP)

(72) Inventors: Hiroyoshi SHIBATA, Tokyo (JP); Masaya Endo, Tokyo (JP)

(73) Assignee: Mitsubishi Electric Corporation, Tokyo (JP)

(21) Appl. No.: 17/871,439

(22) Filed: Jul. 22, 2022

(30) Foreign Application Priority Data
Sep. 22, 2021 (JP) 2021-153762

(51) Int. Cl. B60W 30/09; B60W 30/095; G08G 1/09; G08G 1/16

(52) U.S. Cl. CPC B60W 30/09; B60W 30/0956; G08G 1/091; G08G 1/162; G08G 1/166; B60W 30/0953; B60W 2756/10; B60W 2556/45; B60W 2554/4029

(57) ABSTRACT

A vehicle-exterior-notification control device includes processing circuitry to detect a person present around a crosswalk present in a traveling direction of a first vehicle on a basis of information output from a surrounding information detecting device to detect information around the first vehicle, to detect whether or not the person has an intention to cross the crosswalk before the first vehicle, a vehicle control unit to execute stop control to stop the first vehicle in a case where it is detected that the person has an intention to cross the crosswalk before the first vehicle, to detect a second vehicle present around the first vehicle on a basis of information output from the surrounding information detecting device, and to issue a vehicle-notification instruction for making a notification to the second vehicle in a case where the stop control is executed.

### TECHNICAL FIELD

The present disclosure relates to a vehicle-exterior notification technique.

### BACKGROUND ART

Patent Literature 1 discloses a surrounding information determining technique for controlling autonomous driving of a vehicle. According to an aspect of this surrounding information determining technique, in a situation where a person is present around a crosswalk, when a vehicle having a surrounding information determining device mounted thereon approaches the crosswalk, the approaching vehicle is stopped in front of the crosswalk, and an intention of the person is estimated. In a case where the person does not indicates his or her intention, the person is notified to indicate the intention by sounding a horn or turning on a headlight. In a case where it is estimated that the person indicates the intention in response to the notification and has an intention to stop the vehicle, the vehicle continues to stop.

### CITATION LIST

### Patent Literatures

Patent Literature 1: WO 2018/078713 A

### SUMMARY OF INVENTION

### Technical Problem

There is room for improvement in the surrounding information determining technique of Patent Literature 1 in that, although a notification is made to a person present around a crosswalk, a case where there is a plurality of vehicles that are about to pass the crosswalk is not considered.

The present disclosure has been made for the purpose of improving such a conventional technique, and more specifically, an object of the present disclosure is to provide a vehicle-exterior notification technique capable of contributing to smooth traffic at a crosswalk where a person and a plurality of vehicles are about to pass.

### Solution to Problem

One aspect of a vehicle-exterior-notification control device according to an embodiment of the present disclosure includes processing circuitry to detect a person present around a crosswalk present in a traveling direction of a first vehicle on a basis of information output from a surrounding information detecting device to detect information around the first vehicle, to detect whether or not the person has an intention to cross the crosswalk before the first vehicle, to execute stop control to stop the first vehicle in a case where it is detected that the person has an intention to cross the crosswalk before the first vehicle, to detect a second vehicle present around the first vehicle on a basis of information output from the surrounding information detecting device, and to issue a vehicle-notification instruction for making a. notification to the second vehicle in a case where the stop control is executed.

### Advantageous Effects of Invention

According to one aspect of the vehicle-exterior-notification control device according to the embodiments of the present disclosure, it is possible to contribute to smooth traffic at a crosswalk where a person and a plurality of vehicles are about to pass.

### BRIEF DESCRIPTION OF DRAWINGS

FIG. 1 is a diagram illustrating a configuration example of a vehicle-exterior-notification control device and a vehicle-exterior-notification control system according to a first embodiment and a fourth embodiment.

FIG. 2 is a diagram illustrating a configuration example of a vehicle-exterior-notification control device and a vehicle-exterior-notification control system according to a second embodiment and the fourth embodiment.

FIG. 3 is a diagram illustrating a configuration example of a vehicle-exterior-notification control device and a vehicle-exterior-notification control system according to a third embodiment and the fourth embodiment.

FIG. 4 is a diagram illustrating a configuration example of a vehicle-exterior-notification control device and a vehicle-exterior-notification control system according to a fifth embodiment.

FIG. 5 is a diagram illustrating a configuration example of a vehicle-exterior-notification control device and a vehicle-exterior-notification control system according to a sixth embodiment.

FIG. 6A is a diagram illustrating a hardware configuration example of a vehicle-exterior-notification control device and a server device.

FIG. 6B is a diagram illustrating a hardware configuration example of the vehicle-exterior-notification control device and the server device.

FIG. 7 is a flowchart illustrating a vehicle-exterior-notification control method according to the first embodiment.

FIG. 8 is a flowchart of a modification of the vehicle-exterior-notification control method according to the first embodiment.

FIG. 9 is a flowchart illustrating a vehicle-exterior-notification control method according to the second embodiment.

FIG. 10 is a flowchart illustrating a vehicle-exterior-notification control method according to the third embodiment.

FIG. 11 is a flowchart illustrating a vehicle-exterior-notification control method according to the fourth embodiment.

FIG. 12 is a flowchart illustrating a vehicle-exterior-notification control method according to the fifth embodiment.

FIG. 13 is a flowchart illustrating a vehicle-exterior-notification control method according to the sixth embodiment.

### DESCRIPTION OF EMBODIMENTS

Hereinafter, various embodiments of the present disclosure will be described in detail with reference to the accompanying drawings. Note that components denoted by the same or similar reference numerals in the drawings have the same or similar configurations or functions, and redundant description of such components will be omitted.

First Embodiment

<Configuration>

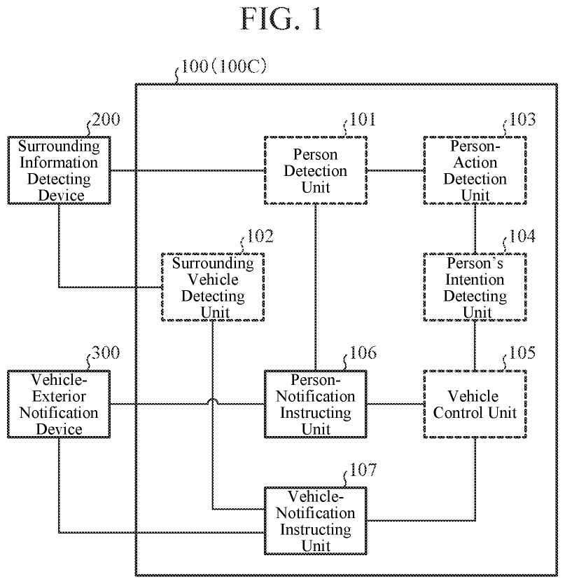

A configuration of a vehicle-exterior-notification control device according to a first embodiment of the present disclosure will be described with reference to FIG. 1. As illustrated in FIG. 1, a vehicle-exterior-notification control device 100 according to the first embodiment is connected to a surrounding information detecting device 200 and a vehicle-exterior notification device 300. The vehicle-exterior-notification control device 100, the surrounding information detecting device 200, and the vehicle-exterior notification device 300 constitute a vehicle-exterior-notification control subsystem. The vehicle-exterior-notification control subsystem is mounted on a vehicle for use. The vehicle on which the vehicle-exterior-notification control subsystem is mounted is hereinafter referred to as “first vehicle”. The vehicle-exterior-notification control subsystem and a server device to be described later constitute a vehicle-exterior-notification control system.

The surrounding information detecting device 200 detects a situation around the first vehicle from an output signal of a sensing device (not illustrated) such as a camera, a sensor, a microphone, a communication device, or a navigation device provided in the first vehicle. In addition, the surrounding information detecting device 200 may acquire a behavior intention of a person who carries a mobile terminal from the mobile terminal present around the first vehicle via the communication device. The detected surrounding situation may also include such a behavior intention. The surrounding information detecting device 200 outputs the detected surrounding situation to a person detection unit 101 and a surrounding vehicle detecting unit 102 of the vehicle-exterior-notification control device 100.

Examples of the vehicle-exterior notification device 300 include a notification device included in the vehicle-exterior-notification control device 100, a notification device provided on a roadside, and a notification device provided in a second vehicle. In a case where an example of the vehicle-exterior notification device 300 is a notification device included in the vehicle-exterior-notification control device 100, the notification device is a device that makes a notification to the outside of the first vehicle on the basis of a control signal from the vehicle-exterior-notification control device 100, and includes, for example, a horn, a headlight, or a tail lamp.

In a case where an example of the vehicle-exterior notification device 300 is a notification device (a roadside device) provided on a roadside, the notification device includes, for example, a display device or a speaker capable of making a notification with display or voice, such as “vehicle is approaching” or “go ahead”. In a case where the roadside device makes a notification, the vehicle-exterior-notification control device 100 performs road-to-vehicle communication via a communication device (not illustrated) and transmits an instruction content to the roadside device.

In a case where an example of the vehicle-exterior notification device 300 is a notification device provided in the second vehicle, this notification device includes, for example, a display device or a speaker capable of making a notification with display or voice, such as “please be careful because the vehicle ahead will give way to a pedestrian” or “please be careful because the vehicle ahead will stop at a crosswalk”. In a case where the notification device provided in the second vehicle makes a notification, the vehicle-exterior-notification control device 100 performs vehicle-to-vehicle communication via a communication device (not illustrated) and transmits an instruction content to the second vehicle.

A notification to a target person to be described later may be made through vehicle-to-vehicle communication between the first vehicle and the second vehicle.

(Vehicle-Exterior-Notification Control Device)

As illustrated in FIG. 1, the vehicle-exterior-notification control device 100 includes, as an example, the person detection unit 101, a person-action detection unit 103, a person's intention detecting unit 104, the surrounding vehicle detecting unit 102, a vehicle control unit 105, a person-notification instructing unit 106, and a vehicle-notification instructing unit 107. In FIG. 1, functional units indicated by broken lines are selective functional units, and functions performed by these functional units may be implemented in a cloud. In a case where a certain function is implemented in the cloud, information input to the functional unit is transmitted from the vehicle-exterior-notification control device 100 to a server device provided in the cloud via a communication device (not illustrated), the server device performs the function, and a processing result is transmitted from the server device to the vehicle-exterior-notification control device 100 via the communication device. In other configuration diagrams, functional units related to functions that can be implemented in the cloud are indicated by broken lines.

(Person Detection Unit)

The person detection unit 101 detects a person present around a crosswalk without a traffic light (hereinafter, simply referred to as “crosswalk”), the crosswalk being present in the traveling direction of the first vehicle, on the basis of surrounding information received from the surrounding information detecting device 200. The detection of the person is performed in a case where the first vehicle approaches within a predetermined distance from the crosswalk. The detection of the person may be performed by performing image analysis on image data indicating a surrounding situation, or may be performed by the first vehicle receiving information that there is a person around the crosswalk from the surrounding information detecting device 200.

The person detection unit 101 determines whether a person is present around the crosswalk by performing person detection. That is, the person detection unit 101 determines that there is a person around the crosswalk in a case where a person is detected, and determines that there is no person around the crosswalk in a case where no person is detected. In addition, the person detection unit 101 determines whether a person (hereinafter, may be referred to as “target person”) who is a target of notification to be described later has finished crossing the crosswalk. A determination result including at least one of these determination results will be referred to as “person determination result”.

The person detection unit 101 outputs the person detection result to the person-action detection unit 103, and outputs the person determination result to the person-notification instructing unit 106.

(Person-Action Detection Unit)

The person-action detection unit 103 detects an action of a target person as person action information on the basis of the person detection result received from the person detection unit 101. Examples of the detected action include a gesture, a line-of-sight direction, and an expression of the target person. The person-action detection unit 103 outputs person presence information indicating the presence or absence of the target person and person action information indicating the action of the detected person to the person's intention detecting unit 104.

(Person's intention Detecting Unit)

The person's intention detecting unit 104 detects whether or not the target person has an intention to cross a crosswalk before the first vehicle on the basis of the person action information received from the person-action detection unit 103. For example, in a case where the target person makes a gesture of “go ahead” with his or her palm spread and his or her forearm extended in a substantially horizontal direction, the person's intention detecting unit 104 may detect that the target person does not have an intention to cross the crosswalk before the first vehicle. Conversely, in a case where the target person does not make such a gesture, it can be estimated that the target person has an intention to cross the crosswalk before the first vehicle. In a. case where such estimation is made and the target person makes a gesture of leaning forward toward the crosswalk, it may be detected that the target person has an intention to cross the crosswalk before the first vehicle. Whether or not the target person has an intention to cross the crosswalk before the first vehicle can be detected on the basis of various types of information. The person's intention detecting unit 104 outputs, to the vehicle control unit 105, person presence information and person's intention information indicating the presence or absence of the intention of the detected target person or the content of the intention.

(Surrounding Vehicle Detecting Unit)

The surrounding vehicle detecting unit 102 detects at least one second vehicle that is present around the first vehicle on the basis of the surrounding information received from the surrounding information detecting device 200. The detection of the second vehicle is performed in a case where the second vehicle approaches within a predetermined distance from a crosswalk. Examples of the second vehicle include a vehicle traveling behind the first vehicle and an oncoming vehicle traveling in the oncoming lane.

The surrounding vehicle detecting unit 102 determines whether there is a second vehicle around the first vehicle by performing the detection of the second vehicle. That is, the surrounding vehicle detecting unit 102 determines that there is a second vehicle around the first vehicle in a case where the second vehicle is detected, and determines that there is no second vehicle around the first vehicle in a case where the second vehicle is not detected. The surrounding vehicle detecting unit 102 outputs a vehicle determination result indicating the presence or absence and the position of the second vehicle to the vehicle-notification instructing unit 107.

(Vehicle Control Unit)

In a case where it is detected that the target person has an intention to cross a crosswalk before the first vehicle on the basis of the received person presence information and person's intention information, the vehicle control unit 105 executes stop control to stop the first vehicle. Note that the overall control function of the vehicle-exterior-notification control device 100 may be performed by the vehicle control unit 105 or may be performed by a control unit (not illustrated).

The vehicle control unit 105 outputs a control signal to a vehicle control device (not illustrated) in accordance with the determined control content to control the operation of the first vehicle. As an example, in a case where the person presence information indicates that there is a target person near the crosswalk, the vehicle control unit 105 controls a vehicle control device (not illustrated) to stop the first vehicle in front of the crosswalk.

As another example, in a case where the person's intention information indicates that the target person has an intention to stop the first vehicle, the vehicle control unit 105 controls a vehicle control device (not illustrated) to stop the first vehicle. In a case where the vehicle is already stopped, the vehicle continues to be stopped.

As another example, in a case where the person's intention information does not indicate that the target person has an intention to stop the first vehicle, a notification is made to the target person, and then the vehicle control unit 105 controls a vehicle control device (not illustrated) to cause the first vehicle to travel.

As another example, in a case where the person presence information indicates that the target person has finished crossing the crosswalk, the vehicle control unit 105 controls a vehicle control device (not illustrated) to cause the first vehicle to travel.

In addition, the vehicle control unit 105 outputs the person's intention information and the vehicle control status information indicating the control status of a vehicle to the person-notification instructing unit 106 and the vehicle-notification instructing unit 107,

(Person-Notification Instructing Unit)

On the basis of the person determination result received from the person detection unit 101 and the person's intention information and the vehicle control status information received from the vehicle control unit 105, the person-notification instructing unit 106 generates a person-notification signal for making a notification to the target person, and outputs the generated person-notification signal to the vehicle-exterior notification device 300.

As an example, in a case where the person determination result indicates that there is a person around a crosswalk, when the vehicle control status information indicates that the vehicle is stopped and the person's intention information indicates that no intention is indicated, the person-notification instructing unit 106 outputs a person-notification signal to the vehicle-exterior notification device 300.

As another example, in a case where the person determination result indicates that there is a person around the crosswalk, when the vehicle control status information indicates that the vehicle is stopped and the content of the intention indicated by the person's intention information is not the content that the person desires to stop the first vehicle, the person-notification instructing unit 106 outputs a person-notification signal to the vehicle-exterior notification device 300.

(Vehicle-Notification Instructing Unit)

On the basis of the vehicle determination result received from the surrounding vehicle detecting unit 102 and the person's intention information and the vehicle control status information received from the vehicle control unit 105, the vehicle-notification instructing unit 107 generates a vehicle-notification signal for making a notification to the second vehicle, and outputs the generated vehicle-notification signal to the vehicle-exterior notification device 300, With the notification, it is possible to notify the second vehicle that the control to stop the first vehicle is to be executed or is executed.

As an example, in a case where the vehicle control status information indicates that the first vehicle is stopped near a crosswalk, when the vehicle detection result indicates the presence of the following vehicle, the vehicle-notification instructing unit 107 outputs a vehicle-notification signal to the vehicle-exterior notification device 300.

As another example, in a case where the content of the intention indicated by the person's intention information is the content that the first vehicle is to be stopped, when the vehicle control status information indicates that the first vehicle has stopped near the crosswalk and the vehicle detection results indicates the presence of the following vehicle, the vehicle-notification instructing unit 107 outputs a vehicle-notification signal to the vehicle-exterior notification device 300.

Since the vehicle-exterior-notification control device 100 includes the vehicle-notification instructing unit 107. it is possible to make a notification to the second vehicle present around the first vehicle, and thus, it is possible to contribute to smooth traffic at a crosswalk where a person and a plurality of vehicles are about to pass. For example, in a case where the first vehicle gives way to a pedestrian who is about to cross the crosswalk, it is possible to prevent the second vehicle following the first vehicle from colliding with the first vehicle. In such a case, it is possible to prevent the second vehicle following the first vehicle from overtaking the first vehicle and colliding with the pedestrian. In addition, in a case where the first vehicle gives way to a pedestrian who is about to cross the crosswalk on a road having a plurality of lanes on one side, it is possible to prevent the second vehicle traveling following the first vehicle in the lane next to the lane in which the first vehicle is traveling from traveling straight without overtaking the first vehicle and colliding with the pedestrian.

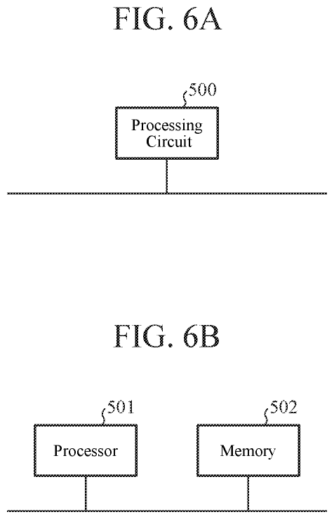

Next, a hardware configuration of the vehicle-exterior-notification control device 100 will be described with reference to FIGS. 6A and 6B. As an example, as illustrated in FIG. 6A. the vehicle-exterior-notification control device 100 is implemented by, for example, a processing circuit 500. The processing circuit 500 is, for example, a single circuit, a composite circuit, a programmed processor, a parallel programmed processor, an application specific integrated circuit (ASIC), a field-programmable gate array (FPGA), or a combination thereof. The functional units of the vehicle-exterior-notification control device 100 may be implemented by separate processing circuits, or these functions can be collectively implemented by one processing circuit.

As another example, as illustrated in FIG. 6B, the vehicle-exterior-notification control device 100 is implemented by, for example, a processor 501 and a memory 502. The program stored in the memory 502 is read and executed by the processor 501, so that each functional unit of the vehicle-exterior-notification control device 100 is implemented. In addition, the memory 502 provides a storage area for storing various data. The program is implemented as software, firmware, or a combination of software and firmware. Examples of the memory 502 include a nonvolatile or volatile semiconductor memory such as a random access memory (RAM), a read only memory (ROM), a flash memory, an erasable programmable read only memory (EPROM), or an electrically-EPROM (EEPROM), a magnetic disk, a flexible disk, an optical disk, a compact disk, a mini disk, and a DVD.

A part of the functions of the vehicle-exterior-notification control device 100 can be implemented by a processing circuit, and another part thereof can be implemented by a processor in cooperation with software or firmware.

Note that the hardware configuration of the vehicle-exterior-notification control device according to second to fifth embodiments to be described later can also be implemented similarly to the hardware configuration of the vehicle-exterior-notification control device 100. In addition, the server device can also be implemented by the hardware configuration of FIG. 6.

<Operation>

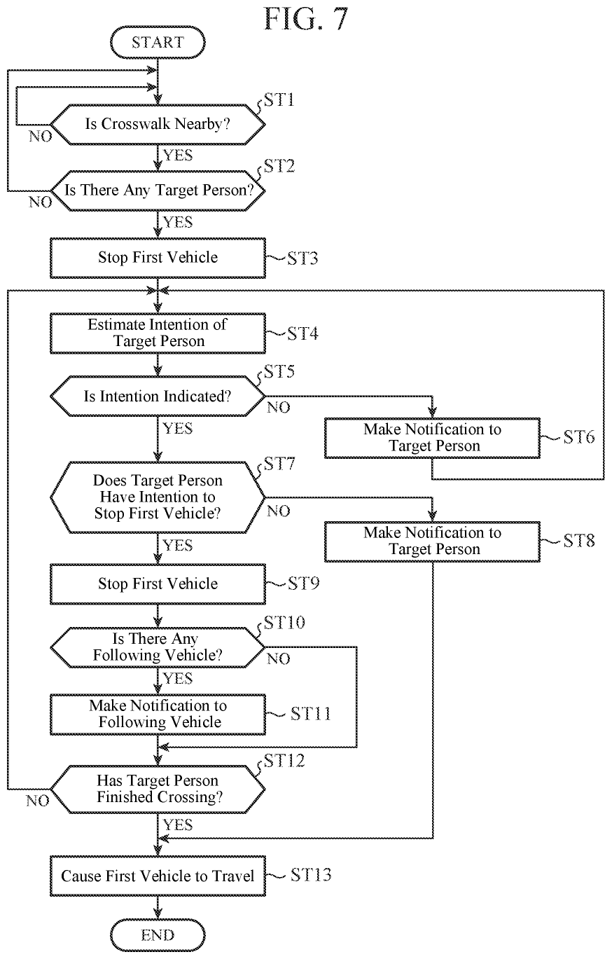

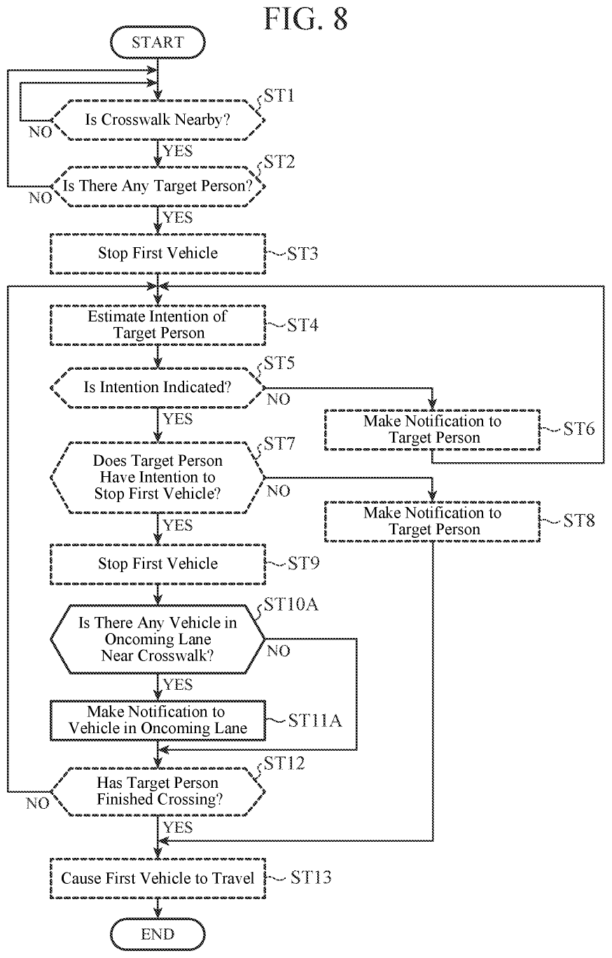

Hereinafter, an operation of the vehicle-exterior-notification control device 100 will be described with reference to FIGS. 7 and 8. FIG. 7 is a flowchart of the vehicle-exterior-notification control device 100 related to a case where the second vehicle is a following vehicle, and FIG. 8 is a flowchart of the vehicle-exterior-notification control device 100 related to a case where the second vehicle is an oncoming vehicle. First, a description will be given with reference to FIG. 7.

In step ST1, the person detection unit 101 determines whether the surrounding situation received from the surrounding information detecting device 200 includes information indicating that a crosswalk is nearby, if the surrounding situation does not include the information indicating that the crosswalk is nearby (No in step ST1), the person detection unit 101 repeats the determination in step ST1 at a predetermined timing.

If the surrounding situation includes the information indicating that the crosswalk is nearby (Yes in step ST1), in step ST2, the person detection unit 101 determines whether there is a person is around the crosswalk by detecting a person (a pedestrian, a person on a bicycle) who is present around the crosswalk from the data indicating the surrounding situation received from the surrounding information detecting device 200.

If there is no target person around the crosswalk (No in step ST2), the process returns to step ST1.

If there is a target person around the crosswalk (Yes in step ST2), in step ST3, the vehicle control unit 105 controls a vehicle control device (not illustrated) to stop the first vehicle in front of the crosswalk.

Subsequent to step ST3, in step ST4, the person-action detection unit 103 detects the action of the target person from a person detection result, and the person's intention detecting unit 104 estimates the intention of the target person on the basis of the detected action of the target person.

Subsequent to step ST4, in step ST5, the person's intention detecting unit 104 determines whether the target person indicates an intention. The presence or absence of the intention is determined on the basis of whether or not the intention of the target person is estimated by the person's intention detecting unit 104. If the target person indicates no intention (No in step ST5), in step ST6, the person-notification instructing unit 106 outputs a control signal to instruct the vehicle-exterior notification device 300 to make a notification to the target person to the vehicle-exterior notification device 300. When receiving the control signal, the vehicle-exterior notification device 300 performs a predetermined operation. In a case where the vehicle-exterior notification device 300 is a headlight, the headlight is turned on. In a case where the vehicle-exterior notification device 300 is a horn, the horn emits sound. With such an operation of the vehicle-exterior notification device 300, the target person is prompted to indicate an intention. After the process in step ST6 is performed, the process returns to step ST4.

If the target person indicates an intention (Yes in step ST5), the person's intention detecting unit 104 determines in step ST7 whether the target person has an intention to stop the first vehicle. That is, it is determined whether the estimated intention of the target person is an intention to stop the first vehicle.

If the person's intention detecting unit 104 determines that the target person does not have an intention to stop the first vehicle (No in step ST7), the person-notification instructing unit 106 outputs a control signal that instructs the vehicle-exterior notification device 300 to make a notification to the target person to the vehicle-exterior notification device 300 in step ST8. When receiving the control signal, the vehicle-exterior notification device 300 performs a predetermined operation. With the notification made by the vehicle-exterior notification device 300, it is possible to attract the attention of the target person to the first vehicle. After the process in step ST8 is performed, the process proceeds to step ST13, in step ST13, the vehicle control unit 105 controls a vehicle control device (not illustrated) to start traveling of the first vehicle (step ST13).

If the target person has an intention to stop the first vehicle (Yes in step ST7), the vehicle control unit 105 controls a vehicle control device (not illustrated) to stop the first vehicle (step ST9). That is, the first vehicle continues to be stopped.

Subsequent to step ST9, in step ST10, the surrounding vehicle detecting unit 102 detects a following vehicle following the first vehicle from the data indicating the surrounding situation received from the surrounding information detecting device 200, and determines whether there is a following vehicle following the first vehicle.

If there is no following vehicle (No in step ST10), the process proceeds to step ST12.

If there is a following vehicle (Yes in step ST10), in step ST11, the vehicle-notification instructing unit 107 outputs a control signal that instructs the vehicle-exterior notification device 300 to make a notification to the following vehicle to the vehicle-exterior notification device 300. When receiving the control signal, the vehicle-exterior notification device 300 performs a predetermined operation. In a case where the vehicle-exterior notification device 300 is a tail lamp, the tail lamp turns on or blinks.

Subsequent to step ST11, in step ST12, the person detection unit 101 determines whether the target person has finished crossing.

If the target person has not finished crossing (No in step ST12), the process returns to step ST4. If the target person has finished crossing (Yes in step ST12), in step ST13, the vehicle control unit 105 controls a vehicle control device (not illustrated) to start traveling of the first vehicle.

Next, an operation in a case where the second vehicle is an oncoming vehicle will be described. In a case where the second vehicle is an oncoming vehicle, step ST10 and step ST11 in FIG. 7 are changed to step ST10A and step ST11A in FIG. 8, respectively. The steps in FIG. 8 are the same as the steps in FIG. 7 except for these steps, and thus the description thereof will be omitted.

In step ST10A, the surrounding vehicle detecting unit 102 detects a vehicle in the oncoming lane near the crosswalk from the data indicating the surrounding situation received from the surrounding information detecting device 200, and determines whether there is a vehicle in the oncoming lane.

If there is no vehicle in the oncoming lane (No in step ST10A), the process proceeds to step ST12.

If there is a vehicle in the oncoming lane (Yes in step ST10A), in step ST11A, the vehicle-notification instructing unit 107 outputs a control signal that instructs the vehicle-exterior notification device 300 to make a notification to the vehicle in the oncoming lane to the vehicle-exterior notification device 300. When receiving the control signal, the vehicle-exterior notification device 300 performs a predetermined operation. In a case where the vehicle-exterior notification device 300 is a headlight, the headlight is turned on or blinks. The headlight may be controlled to emit a high beam (a high beam that is not glare free). In a case where the vehicle-exterior notification device 300 is a horn, the horn emits sound. With such an operation of the vehicle-exterior notification device 300, the first vehicle can notify the vehicle in the oncoming lane that there is a pedestrian crossing the crosswalk.

In a case where both the following vehicle and the vehicle in the oncoming lane are detected as the second vehicle, a notification can be made to both the following vehicle and the vehicle in the oncoming lane.

### Second Embodiment

<Configuration>

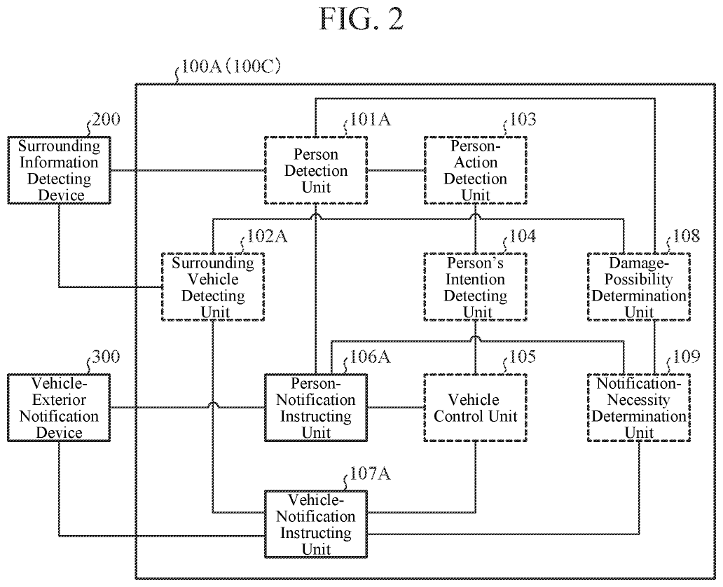

Hereinafter, a configuration of a vehicle-exterior-notification control device according to a second embodiment of the present disclosure will be described with reference to FIG. 2. As illustrated in FIG. 2, a vehicle-exterior-notification control device 100.A according to the second embodiment includes a damage-possibility determination unit 108 and a notification-necessity determination unit 109. which are new functional units, as compared with the vehicle-exterior-notification control device 100 according to the first embodiment. Other functional units of the vehicle-exterior-notification control device 100A are similar to those in the first embodiment, and thus, description thereof will be omitted.

(Damage-Possibility Determination Unit)

The damage-possibility determination unit 108 is connected to a person detection unit 101A and receives a person detection result from the person detection unit 101A. In addition, the damage-possibility determination unit 108 is also connected to a surrounding vehicle detecting unit 102A and receives a vehicle determination result from the surrounding vehicle detecting unit 102A. The damage-possibility determination unit 108 calculates the probability of collision between the detected person and the second vehicle on the basis of a person detection result and the vehicle determination result. The damage-possibility determination unit 108 outputs the calculated probability of collision to the notification-necessity determination unit 109.

(Notification-Necessity Determination Unit)

The notification-necessity determination unit 109 determines whether or not the probability of collision received from the damage-possibility determination unit 108 is lamer than or equal to a predetermined threshold, and determines that a notification is made in a case where the probability of collision is larger than or equal to the predetermined threshold (for example, 1%).

When determining that a notification is to be made, the notification-necessity determination unit 109 outputs a determination result indicating that a notification is required to be made to the second vehicle to a vehicle-notification instructing unit 107A. On the basis of the determination result, the vehicle-notification instructing unit 107A executes notification control on the vehicle-exterior notification device 300. That is, in a case where the probability of collision is larger than or equal to the predetermined threshold, the vehicle-notification instructing unit 107A issues a vehicle-notification instruction.

As an example, in a case where the vehicle control status information indicates that the first vehicle has stopped near a crosswalk, when the vehicle detection result indicates the presence of the second vehicle and the determination result received from the notification-necessity determination unit 109 indicates that a notification is required to be made to the second vehicle, the vehicle-notification instructing unit 107A outputs a vehicle-notification signal to the vehicle-exterior notification device 300.

Furthermore, when determining that a notification is to be made, the notification-necessity determination unit 109 may output a determination result indicating that a notification is required to be made to a target person to a person-notification instructing unit 106A. On the basis of the determination result, the person-notification instructing unit 106A executes notification control on the vehicle-exterior notification device 300. That is, in a case where the probability of collision is larger than or equal to the predetermined threshold, the person-notification instructing unit 106A issues a person-notification instruction.

<Operation>

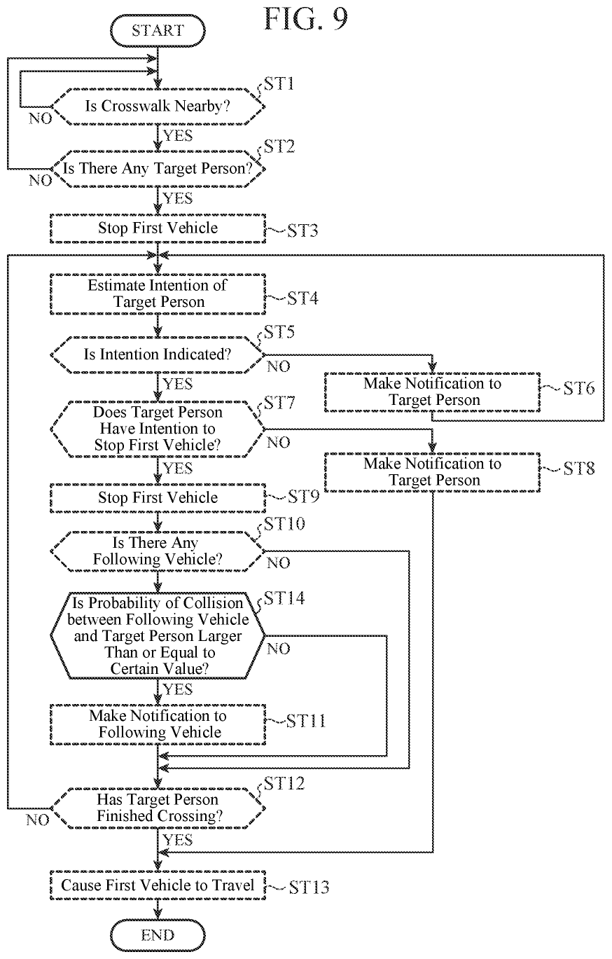

Hereinafter, an operation of the vehicle-exterior-notification control device 100A will be described with reference to FIG. 9. FIG. 9 is a flowchart illustrating the operation of the vehicle-exterior-notification control device 100A in a case where the second vehicle is a following vehicle. In FIG. 9. steps indicated by broken lines are similar to those in FIG. 7. and thus description thereof will be omitted. The flowchart illustrated in FIG. 9 is different from the flowchart illustrated in FIG. 7 in that step ST14 is added between step ST10 and step ST11.

In step ST14, the notification-necessity determination unit 109 determines whether or not the probability of collision between the following vehicle and a target person is larger than or equal to a certain value. That is, it is determined whether or not the possibility that the following vehicle will overtake the first vehicle and collide with the target person is larger than or equal to a certain value. In a case where the probability of collision is larger than or equal to a certain value, the process proceeds to step ST11. In a case where the probability of collision is not larger than or equal to a certain value, the process proceeds to step ST12.

Although the case where the second vehicle is the following vehicle has been described, a case where a vehicle in the oncoming lane is detected as the second vehicle can be processed similarly. That is, in step ST14, the notification-necessity determination unit 109 can determine whether or not the probability of collision between the vehicle in the oncoming lane and the target person is larger than or equal to a certain value.

In a case where both the following vehicle and the vehicle in the oncoming lane are detected as the second vehicle, a notification can be made to both the following vehicle and the vehicle in the oncoming lane.

### Third Embodiment

<Configuration>

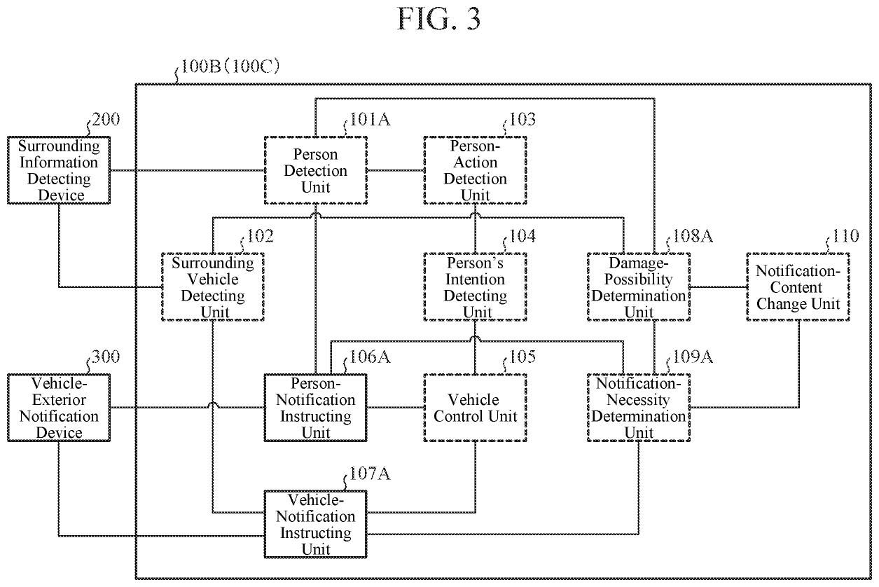

Next, a configuration of a vehicle-exterior-notification control device according to a third embodiment of the present disclosure will be described with reference to FIG. 3. As illustrated in FIG. 3. a vehicle-exterior-notification control device 100B according to the third embodiment includes a notification-content change unit 110, which is a new functional unit, as compared with the vehicle-exterior-notification control device 100A according to the second embodiment. Other functional units of the vehicle-exterior-notification control device 100B are similar to those in the second embodiment, and thus, description thereof will be omitted.

(Notification-Content Change Unit)

The notification-content change unit 110 is connected to a damage-possibility determination unit 108A, and receives the probability of collision between a detected person and the second vehicle from the damage-possibility determination unit 108A. The notification-content change unit 110 determines a notification method depending on the value of the probability of collision obtained by the damage-possibility determination unit 108A, and outputs a notification-method instruction signal that instructs the determined notification method to the notification-necessity determination unit 109. For example, in a case where the probability of collision is larger than or equal to 1% and less than 50%, a signal that instructs a first notification method is output, in a case where the probability of collision is larger than or equal to 50% and less than 100%, a signal that instructs a second notification method is output, and in a case where the probability of collision is 100%, a signal that instructs a third notification method is output. Note that the first, second, and third notification methods are different from each other. This makes it possible to make a notification to the second vehicle depending on the probability of collision.

The notification-necessity determination unit 109A outputs a determination result indicating that a notification is required to be made to the second vehicle and the notification-method instruction signal received from the notification-content change unit 110 to the vehicle-notification instructing unit 107A. On the basis of the determination result and the notification-method instruction signal, the vehicle-notification instructing unit 107A executes notification control on the vehicle-exterior notification device 300. That is, the vehicle-notification instructing unit (107A) issues a vehicle-notification instruction in accordance with the notification method determined by the notification-content change unit 110.

As an example, in a case where the vehicle control status information indicates that the first vehicle has stopped near a crosswalk, when the vehicle detection result indicates the presence of the second vehicle and the determination result received from the notification-necessity determination unit 109A indicates that a notification is required to be made to the second vehicle, the vehicle-notification instructing unit 107A outputs a vehicle-notification signal based on the notification method instructed by the notification-method instruction signal to the vehicle-exterior notification device 300.

<Operation>

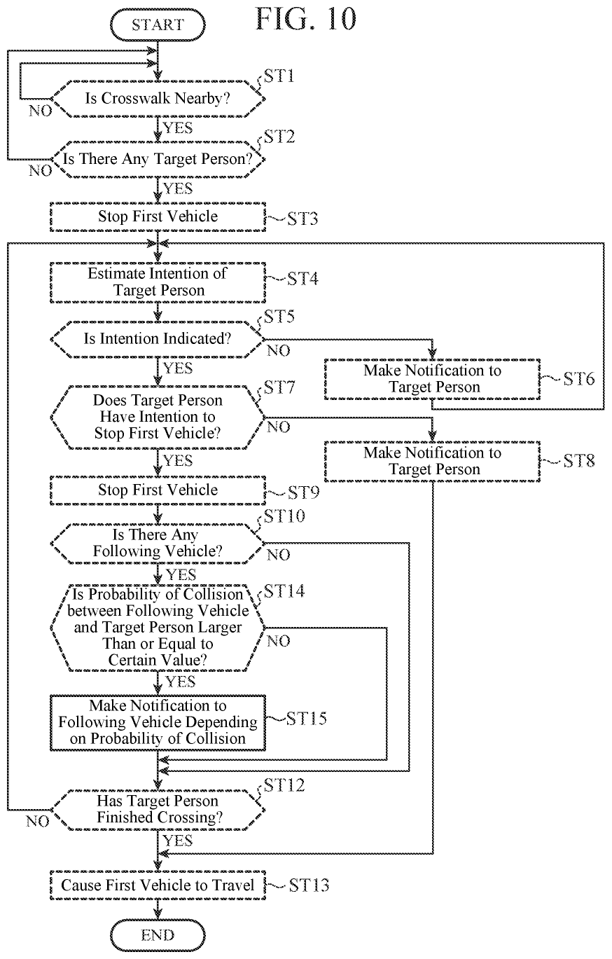

Hereinafter, an operation of the vehicle-exterior-notification control device 100B will be described with reference to FIG. 10. FIG. 10 is a flowchart illustrating the operation of the vehicle-exterior-notification control device 100B in a case where the second vehicle is a following vehicle. In FIG. 10, steps indicated by broken lines are similar to those in FIG. 9, and thus description thereof will be omitted. The flowchart illustrated in FIG. 10 is different from the flowchart illustrated in FIG. 9 in that step ST15 related to a new process is replaced with step ST11 in FIG. 9.

In step ST15, the notification-content change unit 110 outputs a notification-method instruction signal that instructs a notification method depending on the probability of collision between the following vehicle and a target person to the notification-necessity determination unit 109A. In response to the notification-method instruction signal, the vehicle-notification instructing unit 107A controls the vehicle-exterior notification device 300 to make a notification to the following vehicle. After the process in step ST15 is performed, the process proceeds to step ST12.

Although the case where the second vehicle is the following vehicle has been described, a case where a vehicle in the oncoming lane is detected as the second vehicle can be processed similarly. That is, in step ST15, the notification-content change unit 110 may output a notification-method instruction signal that instructs a notification method depending on the probability of collision between the vehicle in the oncoming lane and the target person to the notification-necessity determination unit 109A.

In a case where both the following vehicle and the vehicle in the oncoming lane are detected as the second vehicle, a notification can be made to both the following vehicle and the vehicle in the oncoming lane.

### Fourth Embodiment

<Configuration>

Next, a configuration of a vehicle-exterior-notification control device according to a fourth embodiment of the present disclosure will be described with reference to FIGS. 1 to 3. A configuration of a vehicle-exterior-notification control device 100C according to the fourth embodiment can be any of the configurations illustrated in FIGS. 1 to 3. Hereinafter, the vehicle-exterior-notification control device 100C according to the fourth embodiment will be described as a modification of the vehicle-exterior-notification control device 100 according to the first embodiment, but the same holds true for the vehicle-exterior-notification control device 100B according to the second embodiment or the vehicle-exterior-notification control device 100C according to the third embodiment.

(Surrounding Vehicle Detecting Unit)

In addition to the process described above, the surrounding vehicle detecting unit 102 according to the fourth embodiment checks the movement of a following vehicle or a vehicle in an oncoming lane from the data indicating the surrounding situation received from the surrounding information detecting device 200. For example, after making a notification to the following vehicle or the vehicle in the oncoming lane, the surrounding vehicle detecting unit 102 determines whether or not the following vehicle or the vehicle in the oncoming lane has decelerated or stopped. The surrounding vehicle detecting unit 102 outputs a check result to the vehicle-notification instructing unit 107.

(Vehicle-Notification Instructing Unit)

The vehicle-notification instructing unit 107 executes notification control based on the check result on the basis of the check result received from the surrounding vehicle detecting unit 102. For example, in a case where the check result does not indicate that the following vehicle or the vehicle in the oncoming lane has decelerated or stopped, the vehicle-notification instructing unit 107 controls the vehicle-exterior notification device 300 to make a notification to the following vehicle or the oncoming vehicle again.

Note that the person-notification instructing unit 106 may be configured to be able to receive the check result from the surrounding vehicle detecting unit 102, and the person-notification instructing unit 106 can execute notification control on the basis of the check result. For example, in a case where the check result indicates that the following vehicle or the vehicle in the oncoming lane has decelerated or stopped, the person-notification instructing unit 106 may control the vehicle-exterior notification device 300 to notify a pedestrian that he or she can safely cross the crosswalk. In a case where the check result indicates that all the vehicles detected as the second vehicle have decelerated, the person-notification instructing unit 106 may control the vehicle-exterior notification device 300 to notify a pedestrian that he or she can safely cross the crosswalk,

<Operation>

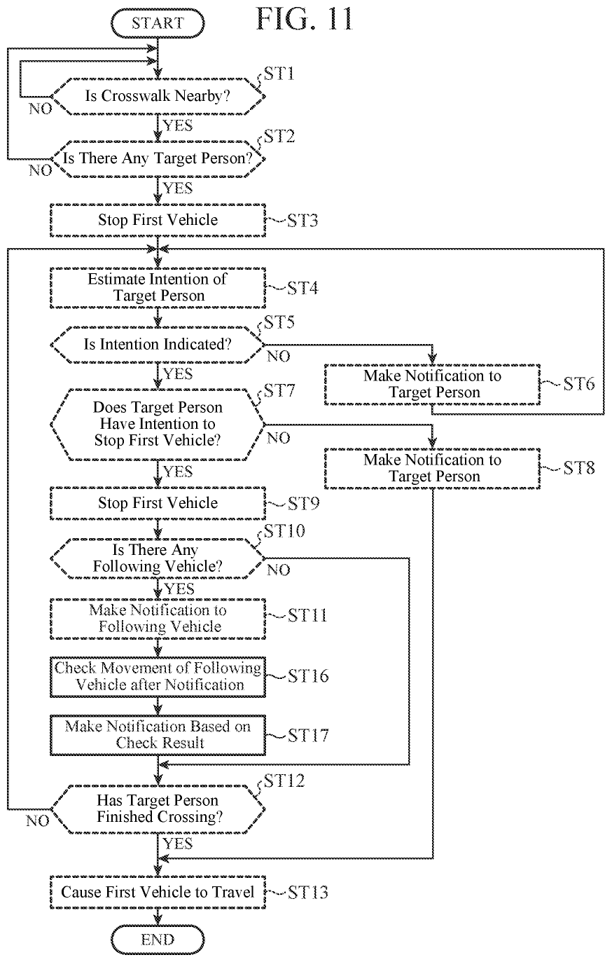

Hereinafter, an operation of the vehicle-exterior-notification control device 100C will be described with reference to FIG. 11. FIG. 11 is a flowchart illustrating the operation of the vehicle-exterior-notification control device 100C in a case where the second vehicle is a following vehicle. In FIG. 11, steps indicated by broken lines are similar to those in FIG. 7, and thus description thereof will be omitted. The flowchart illustrated in FIG. 11 is different from the flowchart illustrated in FIG. 7 in that step ST16 and step ST17 related to new processes are inserted between step ST11 and step ST12 in FIG. 7,

After a notification is made to the following vehicle in step ST11, in step ST16, the surrounding vehicle detecting unit 102 checks the movement of the following vehicle from the data indicating the surrounding situation received from the surrounding information detecting device 200. For example, after making a notification to the following vehicle, the surrounding vehicle detecting unit 102 determines whether or not the following vehicle has decelerated.

In step ST17, the vehicle-notification instructing unit 107 instructs the notification based on a check result on the basis of the processing result in step ST16. For example, in a case where the processing result in step ST16 does not indicate that the following vehicle has decelerated, the vehicle-notification instructing unit 107 controls the vehicle-exterior notification device 300 to make a notification to the following vehicle again.

Although the description of the operation has been given on the basis of the case where the second vehicle is a following vehicle, the same holds true for the case where the second vehicle is a vehicle in the oncoming lane.

### Fifth Embodiment

<Configuration>

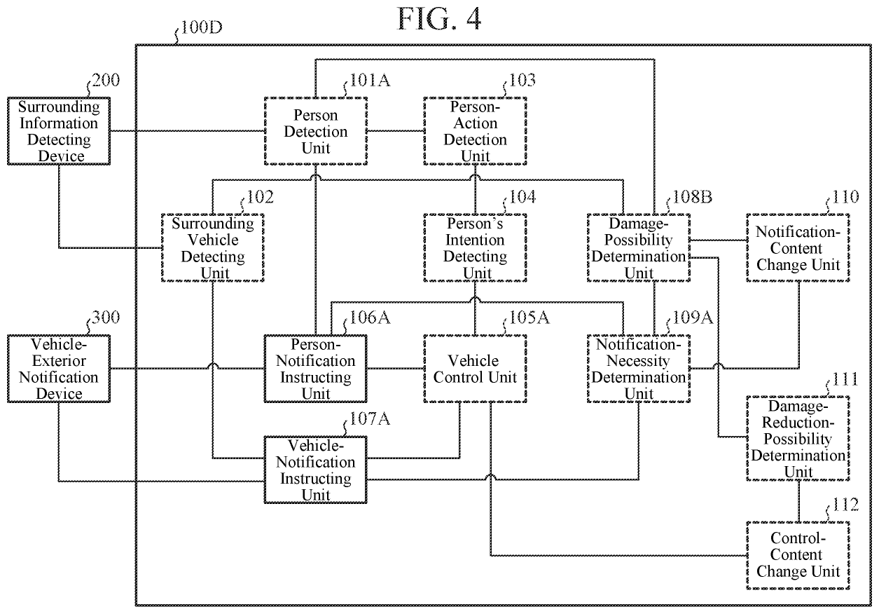

Next, a configuration of a vehicle-exterior-notification control device according to a fifth embodiment of the present disclosure will be described with reference to FIG. 4. A configuration of a vehicle-exterior-notification control device 100D according to the fifth embodiment has a configuration in which a damage-reduction-possibility determination unit 111 and a control-content change unit 112 are added to the configuration illustrated in FIG. 2 or FIG. 3. As an example, the vehicle-exterior-notification control device 1001) will be described in accordance with a mode in which the damage-reduction-possibility determination unit 111 and the control-content change unit 112 are added to the configuration illustrated in FIG. 3.

As illustrated in FIG. 4, the vehicle-exterior-notification control device 100D additionally includes the damage-reduction-possibility determination unit 111 and the control-content change unit 112 as compared with the vehicle-exterior-notification control device 100B illustrated in FIG. 3.

(Damage-Reduction-Possibility Determination Unit)

The damage-reduction-possibility determination unit 111 is connected to a damage-possibility determination unit 108B, and receives the probability of collision between a detected person and the second vehicle from the damage-possibility determination unit 108B. The damage-reduction-possibility determination unit 111 determines whether or not the probability of collision is reduced after a first notification. For example, after the first vehicle makes the first notification to the second vehicle, the damage-reduction-possibility determination unit 111 determines again whether or not the probability of collision is larger than or equal to a predetermined threshold. The damage-reduction-possibility determination unit 111 outputs a determination result indicating whether or not the damage possibility is reduced to the control-content change unit 112.

(Control-Content Change Unit)

In a case where the determination result received from the damage-reduction-possibility determination unit 111 indicates that the possibility of damage is not reduced, the control-content change unit 112 outputs an instruction signal for changing the control content of the first vehicle to a vehicle control unit 105A. The vehicle control unit 105A controls a vehicle control device (not illustrated) in accordance with the instruction signal for changing the control content of the first vehicle. For example, in a case where “deceleration” is included in “stop” of the first vehicle described in accordance with the second embodiment or the third embodiment, the vehicle control unit 105A changes the timing or pace of deceleration of the first vehicle.

The instruction signal output from the control-content change unit 112 may include an instruction related to a notification method. In this case, the vehicle control unit 105A outputs the instruction related to the notification method to the person-notification instructing unit 106 or the vehicle-notification instructing unit 107, thereby controlling the operation of the vehicle-exterior notification device 300. For example, a notification is made to the target person or the second vehicle again. In addition, in a case where the determination result output from the damage-reduction-possibility determination unit 111 indicates that the possibility of damage is reduced, the target person (a pedestrian) may be notified that he or she can safely cross the crosswalk.

<Operation>

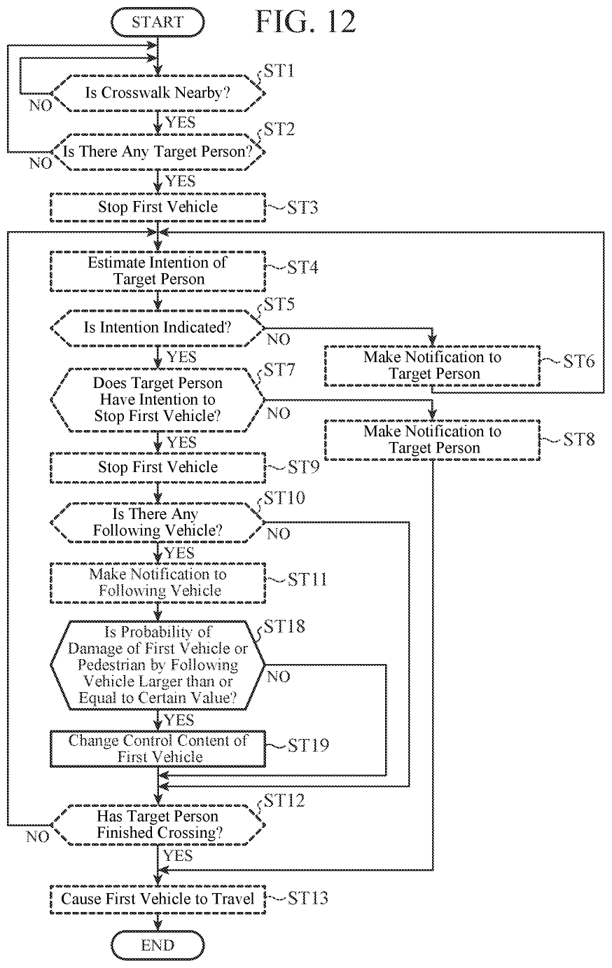

Hereinafter, an operation of the vehicle-exterior-notification control device 100D will be described with reference to FIG. 12. The flowchart illustrated in FIG. 12 is different from the flowchart illustrated in FIG. 7 in that new step ST18 and new step ST19 are inserted between step ST11 and step ST12 in the flowchart illustrated FIG. 7. Redundant description will be omitted, and new steps ST18 and ST19 will be described.

After a notification is made to the following vehicle in step ST11, in step ST18, the damage-reduction-possibility determination unit 111 determines whether or not the probability of damage of the first vehicle or the target person (a pedestrian) by the following vehicle is larger than or equal to a certain value. If the possibility of damage is not larger than or equal to a certain value, the process proceeds to step ST12.

If the probability of damage is larger than or equal to a certain value, in step ST19, the control-content change unit 112 changes the control content of the first vehicle. After the process in step ST19 is performed, the process proceeds to step ST12.

### Sixth Embodiment

<Configuration>

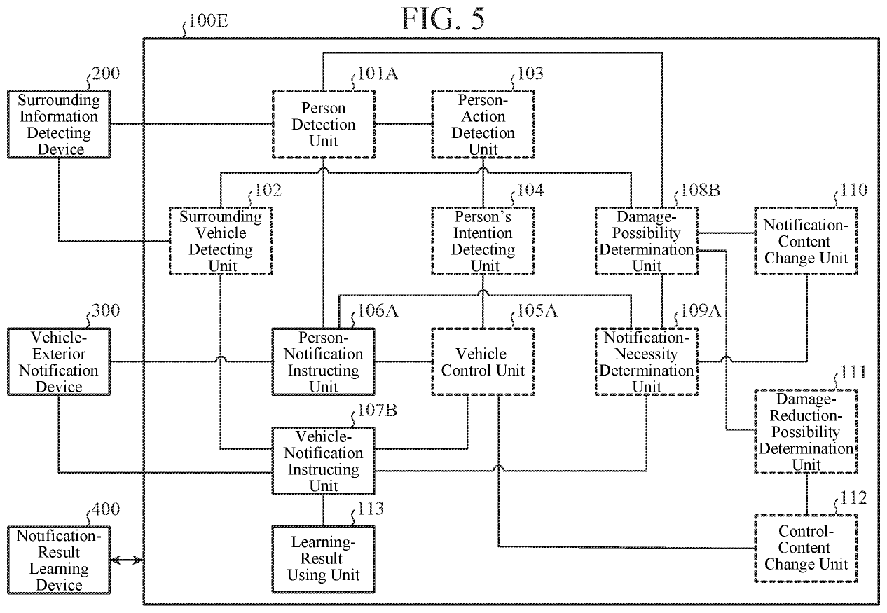

Next, a configuration of a vehicle-exterior-notification control device according to a sixth embodiment of the present disclosure will be described with reference to FIG. 5. As illustrated in FIG. 5, a vehicle-exterior-notification control device 100E according to the sixth embodiment is connected to the surrounding information detecting device 200, the vehicle-exterior notification device 300, and a notification-result learning device 400. The vehicle-exterior-notification control device 100E, the surrounding information detecting device 200, the vehicle-exterior notification device 300, and the notification-result learning device 400 constitute a vehicle-exterior-notification control subsystem.

The notification-result learning device 400 receives notification-performance status information indicating various conditions when the first vehicle makes a notification to the second vehicle and notification result information indicating an operation status of the second vehicle after notification from the vehicle-exterior-notification control device 100E, learns a relationship between the notification-performance status information and the notification result information, and generates a learned model. The learning method may be any of supervised learning, reinforcement learning, and reverse reinforcement learning. The generated learned model may be held in the notification-result learning device 400 and used, or may be installed from the notification-result learning device 400 to a learning-result using unit 113 of the vehicle-exterior-notification control device 100E and used.

(Learning-Result Using Unit)

The learning-result using unit 113 determines a notification method to be performed on the second vehicle using the learned model generated by the notification-result learning device 400. The learning-result using unit 113 inputs the notification-performance status information indicating various conditions when the first vehicle makes a notification to the second vehicle to the learned model, and acquires a notification method output from the learned model. The learning-result using unit 113 outputs a notification control signal indicating the acquired notification method to a vehicle-notification instructing unit 107B, and the vehicle-notification instructing unit 107B controls the vehicle-exterior notification device 300 in accordance with the notification control signal.

<Operation>

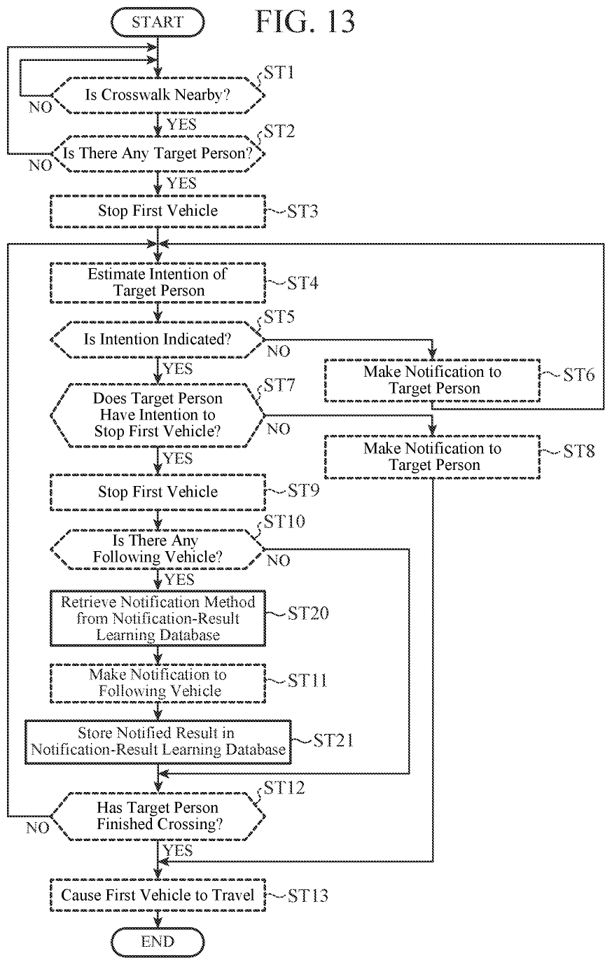

Hereinafter, an operation of the vehicle-exterior-notification control device 100E will be described with reference to FIG. 13. The flowchart illustrated in FIG. 13 is different from the flowchart illustrated in FIG. 7 in that new step ST20 is inserted between step ST10 and step ST11 in the flowchart illustrated in FIG. 7, and new step ST21 is inserted between step ST11 and ST12 in the flowchart illustrated in FIG. 7. Redundant description will be omitted, and new steps ST20 and ST21 will be described.

In step ST20, the learning-result using unit 113 refers to the learned model generated by the notification-result learning device 400 to acquire a notification method to be performed on the following vehicle. The learning-result using unit 113 inputs the notification-performance status information indicating various conditions when the first vehicle makes a notification to the following vehicle to the learned model, and acquires a notification method output from the learned model.

In step ST21, the vehicle-exterior-notification control device 100E outputs notification result information indicating the operation status of the following vehicle after the notification to the notification-result learning device 400.

<Notes>

Some of the various aspects described above are summarized as follows.

(Note 1)

According to one aspect, a vehicle-exterior-notification control device includes a person detection unit (101) to detect a person present around a crosswalk present in a traveling direction of a first vehicle on a basis of information output from a surrounding information detecting device to detect information around the first vehicle, a person's intention detecting unit (104) to detect whether or not the person has an intention to cross the crosswalk before the first vehicle, a vehicle control unit (105; 105A) to execute stop control to stop the first vehicle in a case where it is detected that the person has an intention to cross the crosswalk before the first vehicle, a surrounding vehicle detecting unit (102) to detect a second vehicle present around the first vehicle on a basis of information output from the surrounding information detecting device, and a vehicle-notification instructing unit (107; 107A) to issue a vehicle-notification instruction for making a notification to the second vehicle in a case where the stop control is executed.

(Note 2)

According to one aspect, the vehicle-exterior-notification control device of Note 1 further includes a damage-possibility determination unit (108; 108A; 108B) to obtain a probability of collision between the person and the second vehicle in a case where the stop control is executed, and the vehicle-notification instructing unit issues the vehicle-notification instruction in a case where the probability of collision obtained is larger than or equal to a first threshold.

(Note 3)

According to one aspect, the vehicle-exterior-notification control device of Note 2 further includes a notification-content change unit (110) to determine a notification method depending on a value of a probability of collision obtained by the damage-possibility determination unit, and the vehicle-notification instructing unit issues the vehicle-notification instruction in accordance with the notification method determined.

(Note 4)

According to one aspect, in the vehicle-exterior-notification control device of any one of Notes 1 to 3, the surrounding vehicle detecting unit checks an operation of the second vehicle and outputs a check result after the vehicle-notification instruction is issued, and the vehicle-notification instructing unit issues the vehicle-notification instruction again on a basis of the check result that is output.

(Note 5)

According to one aspect, the vehicle-exterior-notification control device of any one of Notes 1 to 3 further includes a person-notification instructing unit (106; 106A) to execute notification control for a person detected, the surrounding vehicle detecting unit checks an operation of the second vehicle and outputs a check result after the vehicle-notification instruction is issued, and the person-notification instructing unit makes a notification to the person on a basis of the check result that is output.

(Note 6)

According to one aspect, the vehicle-exterior-notification control device of any one of Notes 1 to 5 further includes a damage-reduction-possibility determination unit (111) to determine whether or not a possibility of collision between the person and the second vehicle is reduced in a case where the notification is made to the second vehicle, and a control-content change unit (112) to change a control content of the first vehicle in a case where it is determined that the possibility of collision between the person and the second vehicle is not reduced.

(Note 7)

According to one aspect, in the vehicle-exterior-notification control device according to any one of Notes 1 to 6, a content of the vehicle-notification instruction is obtained from a learned model.

(Note 8)

According to one aspect, a vehicle-exterior-notification control system includes a server device including at least one of a person detection unit (101) to detect a person present around a crosswalk present in a traveling direction of a first vehicle on a basis of information output from a surrounding information detecting device to detect information around the first vehicle, a person's intention detecting unit (104) to detect whether or not the person has an intention to cross the crosswalk before the first vehicle, a vehicle control unit (105; 105A) to execute stop control to stop the first vehicle in a case where it is detected that the person has an intention to cross the crosswalk before the first vehicle, and a surrounding vehicle detecting unit (102) to detect a second vehicle present around the first vehicle on a basis of information output from the surrounding information detecting device, and a vehicle-exterior-notification control device including, out of the person detection unit, the person's intention detecting unit, the vehicle control unit, and the surrounding vehicle detecting unit, all remaining units not included in the server device, and the vehicle-exterior-notification control device further includes a vehicle-notification instructing unit (107) to issue a vehicle-notification instruction for making a notification to the second vehicle in a case where the stop control is executed.

(Note 9)

According to one aspect, a vehicle-exterior-notification control system includes the vehicle-exterior-notification control device of any one of Notes 1 to 7 and a vehicle-exterior notification device (300) to receive the vehicle-notification instruction from the vehicle-exterior-notification control device through vehicle-to-vehicle communication or road-to-vehicle communication and make a notification based on the vehicle-notification instruction.

(Note 10)

According to one aspect, a vehicle-exterior-notification control method performed by a vehicle-exterior-notification control device including a person detection unit (101), a person's intention detecting unit (104), a vehicle control unit (105; 105A), a surrounding vehicle detecting unit (102), and a vehicle-notification instructing unit (107; 107A) includes a step (ST2) of causing the person detection unit to detect a person present around a crosswalk present in a traveling direction of a first vehicle on a basis of information output from a surrounding information detecting device to detect information around the first vehicle, a step (ST5) of causing the person's intention detecting unit to detect whether or not the person has an intention to cross the crosswalk before the first vehicle, a step (ST9) of causing the vehicle control unit to execute stop control to stop the first vehicle in a case where it is detected that the person has an intention to cross the crosswalk before the first vehicle, a step (ST10; ST10A) of causing the surrounding vehicle detecting unit to detect a second vehicle present around the first vehicle on a basis of information output from the surrounding information detecting device, and a step (ST11; ST11A) of causing the vehicle-notification instructing unit to issue a vehicle-notification instruction for making a notification to the second vehicle in a case where the stop control is executed.

Note that the embodiments can be combined, modified or omitted as appropriate.

### INDUSTRIAL APPLICABILITY

The vehicle-exterior-notification control device of the present disclosure can be used as a device that is mounted on a vehicle and controls a notification to a person or another vehicle present around the vehicle.

### REFERENCE SIGNS LIST

100(100A to 100E): vehicle-exterior-notification control device, 101(101A): person detection unit, 102(102A): surrounding vehicle detecting unit, 103: person-action detection unit, 104: person's intention detecting unit, 105(105A): vehicle control unit, 106(106A): person-notification instructing unit, 107(107A): vehicle-notification instructing unit, 108(108A;108B): damage-possibility determination unit, 109(109A): notification-necessity determination unit, 110: notification-content change unit, 111: damage-reduction-possibility determination unit, 112: control-content change unit, 113: learning-result using unit, 200: surrounding information detecting device, 300: vehicle-exterior notification device, 400: notification-result learning device, 500: processing circuit, 501: processor, 502: memory

1. A vehicle-exterior-notification control device comprising:
processing circuitry
to detect a person present around a crosswalk present in a traveling direction of a first vehicle on a basis of information output from a surrounding information detecting device to detect information around the first vehicle;
to detect whether or not the person has an intention to cross the crosswalk before the first vehicle;
to execute stop control to stop the first vehicle in a case where it is detected that the person has an intention to cross the crosswalk before the first vehicle;
to detect a second vehicle present around the first vehicle on a basis of information output from the surrounding information detecting device; and
to issue a vehicle-notification instruction for making a notification to the second vehicle in a case where the stop control is executed.

2. The vehicle-exterior-notification control device according to claim 1, wherein the processing circuitry is further configured
to obtain a probability of collision between the person and the second vehicle in a case where the stop control is executed, and
to issue the vehicle-notification instruction in a case where the probability of collision obtained is larger than or equal to a first threshold.

3. The vehicle-exterior-notification control device according to claim 2, wherein the processing circuitry is further configured
to determine a notification method depending on a value of the obtained probability of collision, and
to issue the vehicle-notification instruction in accordance with the notification method determined.

4. The vehicle-exterior-notification control device according to claim 1, wherein
the processing circuitry checks an operation of the second vehicle after the vehicle-notification instruction is issued, and
issues the vehicle-notification instruction again on a basis of the check result.

5. The vehicle-exterior-notification control device according to claim 1, wherein the processing circuitry is further configured to execute notification control for a person detected, wherein
the processing circuitry checks an operation of the second vehicle after the vehicle-notification instruction is issued, and
makes a notification to the person on a basis of the check result.

6. The vehicle-exterior-notification control device according to claim 1, wherein the processing circuitry is further configured
to determine whether or not a possibility of collision between the person and the second vehicle is reduced in a case where the notification is made to the second vehicle; and
to change a control content of the first vehicle in a case where it is determined that the possibility of collision between the person and the second vehicle is not reduced.

7. The vehicle-exterior-notification control device according to claim 1, wherein a content of the vehicle-notification instruction is obtained from a learned model.

8. A vehicle-exterior-notification control system comprising:
a server device including a first processing circuitry to perform at least one process of:
detecting a person present around a crosswalk present in a traveling direction of a first vehicle on a basis of information output from a surrounding information detecting device to detect information around the first vehicle,
detecting whether or not the person has an intention to cross the crosswalk before the first vehicle,
executing stop control to stop the first vehicle in a case where it is detected that the person has an intention to cross the crosswalk before the first vehicle, and
detecting a second vehicle present around the first vehicle on a basis of information output from the surrounding information detecting device; and
a vehicle-exterior-notification control device including a second processing circuitry to perform all remaining processes not performed by the server device, wherein
the second processing circuitry of the vehicle-exterior-notification control device is further configured to issue a vehicle-notification instruction for making a notification to the second vehicle in a case where the stop control is executed.

9. A vehicle-exterior-notification control system comprising:
the vehicle-exterior-notification control device according to claim 1; and
a vehicle-exterior notification device to receive the vehicle-notification instruction from the vehicle-exterior-notification control device through vehicle-to-vehicle communication or road-to-vehicle communication and make a notification based on the vehicle-notification instruction.

10. A vehicle-exterior-notification control method comprising:
detecting a person present around a crosswalk present in a traveling direction of a first vehicle on a basis of information output from a surrounding information detecting device to detect information around the first vehicle;
detecting whether or not the person has an intention to cross the crosswalk before the first vehicle;
executing stop control to stop the first vehicle in a case where it is detected that the person has an intention to cross the crosswalk before the first vehicle;
detecting a second vehicle present around the first vehicle on a basis of information output from the surrounding information detecting device; and
issuing a vehicle-notification instruction for making a notification to the second vehicle in a case where the stop control is executed.

11. The vehicle-exterior-notification control device according to claim 2, wherein the processing circuitry checks an operation of the second vehicle after the vehicle-notification instruction is issued, and issues the vehicle-notification instruction again on a basis of the check result.

12. The vehicle-exterior-notification control device according to claim 3, wherein the processing circuitry checks an operation of the second vehicle after the vehicle-notification instruction is issued, and issues the vehicle-notification instruction again on a basis of the check result.

13. The vehicle-exterior-notification control device according to claim 2, wherein the processing circuitry is further configured to execute notification control for a person detected, wherein the processing circuitry checks an operation of the second vehicle after the vehicle-notification instruction is issued, and makes a notification to the person on a basis of the check result.

14. The vehicle-exterior-notification control device according to claim 3, wherein the processing circuitry is further configured to execute notification control for a person detected, wherein the processing circuitry checks an operation of the second vehicle after the vehicle-notification instruction is issued, and makes a notification to the person on a basis of the check result.

15. The vehicle-exterior-notification control device according to claim 2, wherein the processing circuitry is further configured
to determine whether or not a possibility of collision between the person and the second vehicle is reduced in a case where the notification is made to the second vehicle; and
to change a control content of the first vehicle in a case where it is determined that the possibility of collision between the person and the second vehicle is not reduced.

16. The vehicle-exterior-notification control device according to claim 3, wherein the processing circuitry is further configured
to determine whether or not a possibility of collision between the person and the second vehicle is reduced in a case where the notification is made to the second vehicle; and
to change a control content of the first vehicle in a case where it is determined that the possibility of collision between the person and the second vehicle is not reduced.

17. The vehicle-exterior-notification control device according to claim 4, wherein the processing circuitry is further configured
to determine whether or not a possibility of collision between the person and the second vehicle is reduced in a case where the notification is made to the second vehicle; and
to change a control content of the first vehicle in a case where it is determined that the possibility of collision between the person and the second vehicle is not reduced.

18. The vehicle-exterior-notification control device according to claim 5, wherein the processing circuitry is further configured
to determine whether or not a possibility of collision between the person and the second vehicle is reduced in a case where the notification is made to the second vehicle; and
to change a control content of the first vehicle in a case where it is determined that the possibility of collision between the person and the second vehicle is not reduced.
